(19) United States
(12) Patent Application Publication
(10) Pub. No.: US 2024/0221762 A1
(43) Pub. Date: Jul. 4, 2024

(54) SYSTEM AND METHOD FOR SILENT SPEECH DECODING

(71) Applicant: Wispr AI, Inc., South San Francisco, CA (US)

(72) Inventors: Sahaj Garg, Foster City, CA (US); Anthony Leonardo, Broadlands, VA (US); Tanay Kothari, San Francisco, CA (US)

(73) Assignee: Wispr AI, Inc., South San Francisco, CA (US)

(21) Appl. No.: 18/403,952

(22) Filed: Jan. 4, 2024

Related U.S. Application Data
(60) Provisional application No. 63/437,088, filed on Jan. 4, 2023.

(51) Int. Cl. G10L 19/012; G10L 19/04

(52) U.S. Cl. CPC G10L 19/012; G10L 19/04

(57) ABSTRACT

Systems and methods are provided for decoding the silent speech of a user. Speech of the user (e.g., silent, vocalized, etc.) may be detected and captured by a speech input device configured to measure signals indicative of the speech muscle activation patterns of the user. A trained machine learning model configured to decode the speech of the user based at least in part on the signal indicative of the speech muscle activation patterns of the user. To improve accuracy of the model, the trained machine learning model may be trained using training data obtained in at least a subset of sampling contexts of a plurality of sampling contexts. At least one processor may be configured to output the decoded speech of the user.

### CROSS-REFERENCE TO RELATED APPLICATIONS

This application claims the benefit under 35 U.S.C. § 119(e) of U.S. Provisional Application No. 63/437,088, entitled “SYSTEMS AND METHODS FOR SILENT SPEECH DECODING,” filed Jan. 4, 2023, the entire contents of which are incorporated herein by reference.

### TECHNICAL FIELD

This invention relates generally to the speech decoding field, and more specifically to speech decoding.

### SUMMARY

Voiced speech training data (e.g., including EMG data acquired during voiced speech and labeled with corresponding text) and silent speech training data (e.g., including EMG data acquired during silent speech and labeled with corresponding text) share sufficient similarities such that the voiced speech training data can be used to train a silent speech recognition model, despite being measured in different speaking domains. For example, a majority of the training data used to train the model can be voiced speech training data. In variants, using voiced speech training data in addition to or in place of silent speech training data can make data collection easier, more accurate, and more diverse.

According to one aspect, a system for decoding speech of a user is provided. The system may comprise a speech input device configured to measure a signal indicative of the speech muscle activation patterns of the user while the user is speaking; a trained machine learning model configured to decode the speech of the user based at least in part on the signal indicative of the speech muscle activation patterns of the user, wherein the trained machine learning model is trained using training data obtained in at least a subset of sampling contexts of a plurality of sampling contexts; and at least one processor configured to output the decoded speech of the user.

In some embodiments, the plurality of sampling contexts may comprise a plurality of vocalization levels. In some embodiments, the plurality of vocalization levels may comprise a spectrum of vocalization levels from silent speech to vocalized speech. In some embodiments, the spectrum of vocalization levels from silent speech to vocalized speech comprises a discrete spectrum of vocalization levels. For example, the spectrum may include 2, 5, 10, 20 or any other suitable number of vocalization levels. In some embodiments, the spectrum of vocalization levels from silent speech to vocalized speech may comprise a continuous spectrum of vocalization levels.

In some embodiments, the plurality of sampling contexts may further comprise a plurality of activity-based sampling contexts. In some embodiments, the plurality of activity-based sampling contexts may comprise two or more of: walking, running, jumping, standing, or sitting, or any suitable activity-based sampling contexts. In some embodiments, the plurality of sampling contexts may further comprise a plurality of environmental-based sampling contexts. In some embodiments, each of the sampling contexts of the plurality of environmental-based sampling contexts are based at least in part on a location and a noise level of the sampling context. In some embodiments, each of the sampling contexts of the plurality of environmental-based sampling contexts are based at least in part on the electrical properties of the sampling context.

In some embodiments, the trained machine learning model may be associated with the user. In some embodiments, the trained machine learning model may comprise a plurality of layers; and associating the trained machine learning model with the user may comprise associating at least one layer of the plurality of layers with the user. In some embodiments, at least a subset of the training data may be obtained from signals produced by the user; and associating the trained machine learning model with the user comprises training the machine learning model using the subset of the training data obtained from signals produced by the user. In some embodiments, associating the trained machine learning model with the user comprises using as input to the trained machine learning model, a conditioning flag associated with the user.

In some embodiments, the speech input device may be further configured to obtain voiced speech measurements when the user is speaking vocally; and the training machine learning model is a first trained machine learning model configured to associate a first signal indicative of the speech muscle activation patterns of the user when the user is speaking silently with a first voiced speech measurement when the user is speaking vocally; and the system further comprises a second trained machine learning model configured to generate an audio and/or text output when the user is speaking silently based at least in part on the association of the first signal indicative of the speech muscle activation patterns of the user with the first voice speech measurement.

Still other aspects, examples, and advantages of these exemplary aspects and examples are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE FIGURES

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1 is a schematic representation of a variant of the method, according to some embodiments.

FIG. 2 depicts an example of labeling training data, according to some embodiments.

FIG. 3 depicts a first example of decoding silent speech, according to some embodiments.

FIG. 4 depicts a second example of decoding silent speech, according to some embodiments.

FIG. 5 depicts an example of training a model, according to some embodiments.

FIG. 6A depicts an example of training an ensemble model, including training an embedding layer, according to some embodiments.

FIG. 6B depicts an example of training an ensemble model, including training a model to decode embedded training data, according to some embodiments.

FIG. 7 depicts a second example of training an ensemble model, according to some embodiments.

FIG. 8 depicts an illustrative example of training a silent speech decoding model using voiced speech training data, according to some embodiments.

FIG. 9A depicts an example speech input device, according to some embodiments.

FIG. 9B depicts an example speech input device, according to some embodiments.

FIG. 10A is a perspective view of a wearable speech input device having an ear hook embodiment and wearable on a user's ear, according to some embodiments.

FIG. 10B is an illustration of wearable device target zone(s) associated with a wearable speech input device, according to some embodiments.

### DETAILED DESCRIPTION

The following description of the embodiments of the invention is not intended to limit the invention to these embodiments, but rather to enable any person skilled in the art to make and use this invention.

### 1. Overview

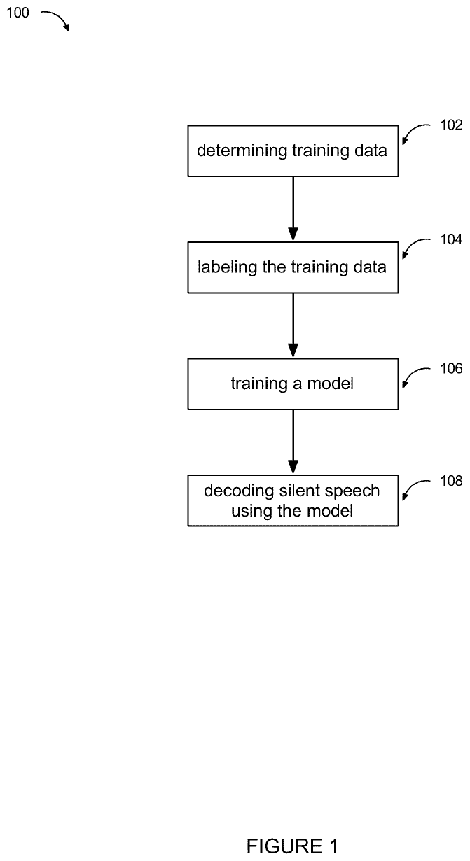

As shown in FIG. 1, the method 100 can include: determining training data at step 102, labeling the training data at step 104, training a model at step 106, and decoding silent speech using the model at step 108.

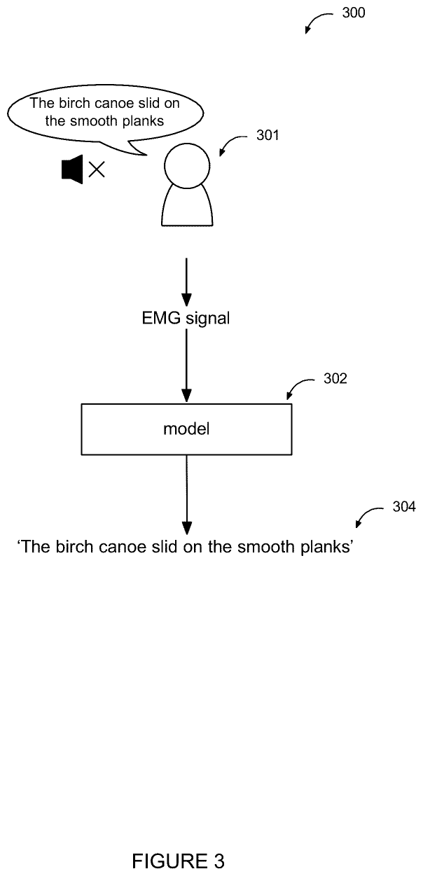

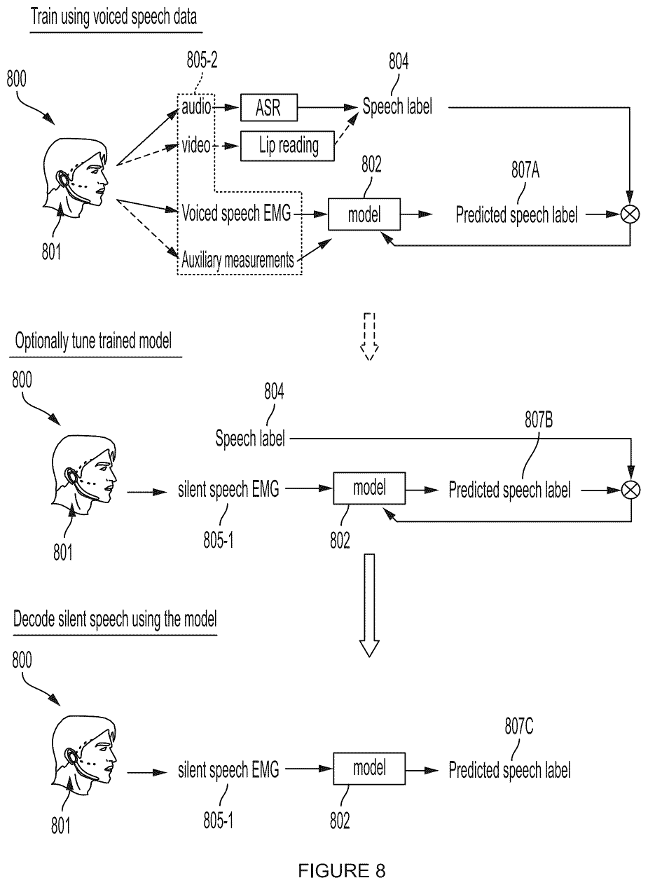

In variants, the method can function to train a model to decode silent speech. For example, an end user speaks silently, and the model converts measured signals (e.g., EMG signals) into speech (e.g., in text form); examples shown in FIG. 3 and FIG. 8.

### 2. Examples

In an example, measurements (e.g., EMG signals) can be sampled while a user communicates a phrase via silent speech, wherein a model trained using voiced speech measurements can determine the phrase (e.g., in text form) based on the measurements (e.g., illustrative example shown in FIG. 8).

In a first example, the model is trained to predict predetermined text and/or audio (e.g., a predetermined prompt, user-entered text and/or audio, etc.) based on silent speech measurements (e.g., EMG signals). In a second example, the model is trained to predict text and/or audio (e.g., a predetermined prompt, text extracted using automated speech recognition from an associated audio recording, etc.) based on voiced speech measurements (e.g., EMG signals, accelerometer, etc.). The model can optionally be tuned using silent speech measurements (e.g., illustrative example shown in FIG. 8). In a third example, the model is an ensemble model including a first model trained to convert silent speech measurements to an encoding shared with voiced speech measurements for the same speech label (e.g., text prompt), and a second model trained to decode the encoding into a text and/or audio output.

### 3. Technical Advantages

Variants of the technology can confer one or more advantages over conventional technologies.

The inventors have discovered that, unexpectedly, voiced speech training data (e.g., including EMG data acquired during voiced speech and labeled with corresponding text) and silent speech training data (e.g., including EMG data acquired during silent speech and labeled with corresponding text) share sufficient similarities such that the voiced speech training data can be used to train a silent speech recognition model, despite being measured in different speaking domains. For example, in some implementations, a majority of the training data used to train the model can be voiced speech training data.

In variants, using voiced speech training data in addition to or in place of silent speech training data can make data collection easier, more accurate, and more diverse. In a first example, training data collection can include a subject speaking (silently and/or aloud) words in a prompt, wherein the training data includes EMG data is labeled with the prompt text. In this example, the voiced speech training data can be more accurate than the silent speech training data because the voiced speech label can be corrected and/or validated using voiced speech recognition methods. In a second example, voiced speech training data can be captured in natural-use contexts in addition to or in place of controlled environments, which can provide a more diverse training dataset and/or a training dataset that more accurately reflects the inference use case.

However, further advantages can be provided by the system and method disclosed herein.

### 4. Method

As shown in FIG. 1, a method 100 can include: determining training data at step 102, labeling the training data at step 104, training a model at step 106, and decoding silent speech using the model at step 108.

All or portions of the method can be performed in real time (e.g., responsive to a request), iteratively, asynchronously, periodically, one or more times for an individual training subject, one or more times for a set of training subjects, and/or at any other suitable time. All or portions of the method can be performed automatically, manually, semi-automatically, and/or otherwise performed.

All or portions of the method can be performed by a system including: one or more measurement systems, a user device, one or more end user and/or training subjects, a computing system, a database, and/or any other suitable system. The computing system can include one or more: CPUs, GPUs, custom FPGA/ASICS, microprocessors, servers, cloud computing, and/or any other suitable components. The computing system can be local, remote, distributed, or otherwise arranged relative to any other system or module.

Determining training data at step 102 functions to sample and/or otherwise generate data that can be used as model inputs during model training. Step 102 can be performed for an individual training subject, for a set of training subjects, for one or more collection domains, and/or otherwise performed.

Training data can optionally be associated with a collection domain. In a first variant, the collection domain is a voiced domain, wherein a training subject uses voiced speech characterized by a presence of vocal fold vibration and/or a sound level above a threshold. In a second variant, the collection domain is a whispered domain, wherein a training subject uses whispered speech characterized by an absence of vocal fold vibration, a sound level below a first threshold, and/or a sound level above a second threshold (e.g., non-silent). In a third variant, the collection domain is a silent domain, wherein a training subject uses silent speech characterized by an absence of vocal fold vibration, a sound level equal to 0, and/or a sound level below a threshold (e.g., allowing lip and/or mouth noises, slight whispering, etc.). The silent domain can optionally include subvocalization.

The target domain (e.g., a domain used for inference) is preferably the silent domain, but can additionally or alternatively include the whispered domain and/or any other domain. The source domain is preferably the voiced domain and/or the whispered domain, but can additionally or alternatively include the silent domain and/or any other domain. Preferably, more than a threshold proportion of the training data and/or a subset of the training data (e.g., a subset including all non-synthetic training data) is collected in the source domain. The threshold proportion can be between 20%-100% or any range or value therebetween (e.g., 50%, 60%, 70%, 80%, 90%, 95%, etc.), but can alternatively be less than 20%. However, data collected in the source domain can make up any proportion of the training data.

Training data can be determined in one or more sampling contexts.

In a first variant, the sampling context includes the training subject being presented with a prompt (e.g., in a data collection center), wherein the training subject speaks the prompt in the collection domain (e.g., voiced, whispered, silent, etc.). The prompt can be a text prompt (e.g., a script), audio prompt, and/or any other prompt. For example, the training subject is shown a phrase on a screen and is asked to repeat the phrase using voiced speech, whispered speech, and/or silent speech. In specific examples, the training subject can be asked to use voiced speech in one or more voiced speech trials, silent speech in one or more silent speech trials, and/or whispered speech in one or more whispered speech trials (e.g., each trial corresponding to a single prompt, a set of prompts, etc.). Voiced speech trials can optionally be interspersed between sets of silent speech trials. For example, a voiced speech trial can be used every K silent speech trials, wherein K can be between 1-1000 or any range or value therebetween (e.g., 5-100), but can alternatively be greater than 1000. In variants, this can provide auditory feedback which can improve accuracy of training data collection, training data labeling, and/or otherwise improve model training. In other variants, the inferred text from the silent or whispered speech can be played back to the training subject. The training subject and/or another person can optionally delineate the start and/or end of each: prompt, sentence within the prompt, word within the prompt, syllable within the prompt, and/or any other segment of the prompt. Additionally or alternatively, auxiliary measurements (e.g., video of the training subject while speaking, inertial measurements, audio, etc.) sampled during test subject speaking can be used to determine the prompt segmentation (e.g., each segment's start and end timestamps).

In a second variant, the sampling context does not include a prompt (e.g., spontaneous speech). For example, the training subject can be speaking (e.g., voiced, whispered, silent, etc.) and/or performing other actions in their usual environment (e.g., attending meetings, taking phone calls, etc.) while the training data (e.g., background training data) is sampled. The background training data can be collected: responsive to operation mode selection by the user (e.g., turning on the device, user indication to interpret the signals, etc.) and/or without operation mode selection by the user (e.g., continuous data collection, automatic data collection responsive to a sensed event, etc.). In examples, background training data collected without explicit prompts can enable: training and/or calibrating a personalized model (e.g., as described in step 106; optionally without an explicit calibration step performed using prompted speech), continual model training/calibrating (e.g., outside of data collection centers; while all or parts of the system are not in active use for silent speech decoding and/or for controlling a device based on decoded silent speech; etc.), decreased silent speech decoding errors, and/or provide other advantages. In examples, the collected data can be cached for a threshold period of time (e.g., 1 min, 5 min, enough time to tune the model, etc.) then discarded; alternatively, features from the collected data can be extracted and stored, which can allow the collected data to be discarded (e.g., in real- or near-real time).

In any variant, sampling context can include user motion (e.g., sitting, walking, jumping up and down, etc.), user actions (e.g., typing, texting, reading, etc.), and/or any other context associated with the training data. However, the sampling context can be otherwise defined.

In a first variant, determining training data includes sampling training data using one or more measurement systems. The measurement systems can include: electrophysiology measurement systems (e.g., to collect EMG signals, EEG signals, EOG signals, ECG signals, EKG signals, etc.), other biometric measurement systems, motion sensor (e.g., IMU), microphone, optical sensors that detect the movement of the skin (e.g., infrared cameras with a dot matrix projector), video cameras (e.g., to capture images, videos, motion capture data, etc.), sensors that can detect blood flow (e.g., PPG, fNIRS), thermal cameras, ToF sensors, and/or any other measurement systems. Data collected from a measurement system can correspond to a measurement modality.

In an example, EMG sensors can be placed on a training subject: on and/or under the jaw, on the check, at and/or below the check bone, at and/or near the temporomandibular joint, and/or any other location on the face. The EMG sensors are optionally positioned more than a threshold distance away from the face midline. In variants, this can enable the EMG sensors to be less intrusive and/or more ergonomic. The threshold distance can be between 2 cm-15 cm or any range or value therebetween, but can alternatively be less than 2 cm or greater than 15 cm. EMG sensors can optionally be positioned on only one side of the face. The number of EMG sensors can be between 2-100 or any range or value therebetween (e.g., 5-20), but can alternatively be less than 2 or greater than 100.

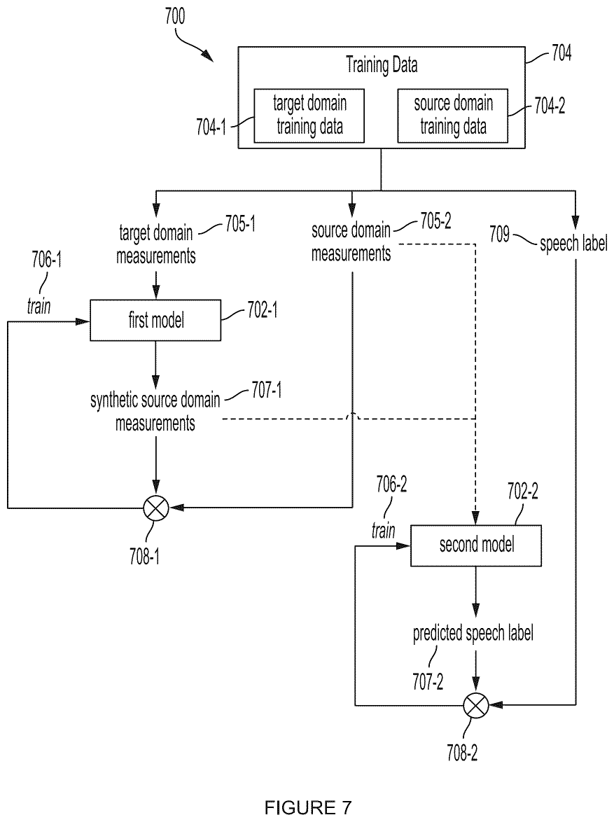

In a second variant, determining training data includes synthetically generating training data. In a first example, synthetic silent domain measurements can be generated by sampling voiced domain measurements and subtracting out glottal vibrations (e.g., determined using an accelerometer, a microphone, etc.). In a second example, a model can be trained to generate synthetic silent domain measurements based on voiced domain measurements (e.g., using paired silent and voiced measurements for the same training subject, for the same text prompt, etc.); example shown in FIG. 7. In specific examples, the model can use generative and/or de-noising methods (e.g., Stable Diffusion). In a third example, a relationship between sets of source domain training data can be used to augment target domain training data. For example, voiced speech training data can include paired examples of a training subject using voiced speech across two or more sampling contexts (e.g., sitting, walking, jumping up and down, other actions, etc.). A mapping function can be inferred between two sampling contexts (e.g., sitting to walking), wherein the mapping function can be applied to silent speech training data sampled in the first sampling context to generate synthetic silent speech training data in the second sampling context. In a fourth example, synthetic training data can be generated by introducing artifacts and/or otherwise altering sampled training data. However, training data can be otherwise synthetically generated.

However, training data can be otherwise determined.

Labeling the training data at step 104 functions to pair the training data (e.g., EMG measurements) with speech labels. Speech labels can include text, audio, word segmentation, phrase segmentation, intonation, and/or any other speech information.

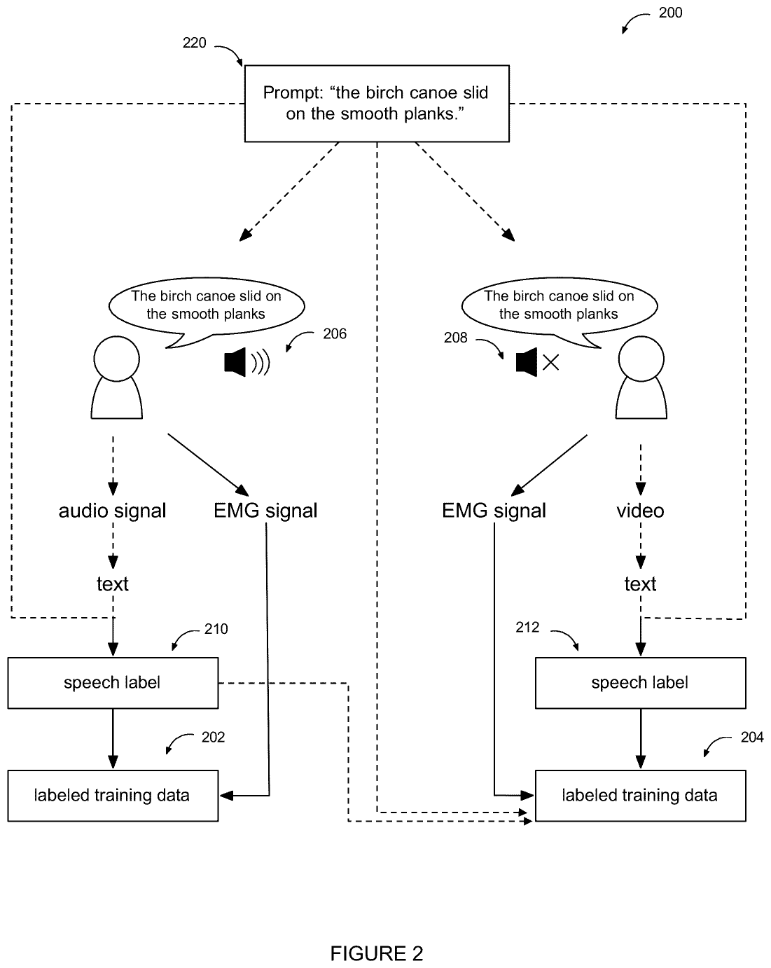

In a first variant, the speech label includes a prompt (e.g., text from a prompt). In a second variant, the speech label includes text and/or audio determined based on ground truth measurements. Ground truth measurements can include: audio, video, motion capture data, and/or any other measurement modalities. Ground truth measurement systems can include: a microphone, a video camera, and/or any other measurement system. In a first example, ground truth audio signals are converted to a text speech label (e.g., using automatic speech recognition methods, manually converted, etc.); example shown in FIG. 8. In a second example, ground truth videos are converted to a text speech label (e.g., using automated lip-reading methods, manually converted, etc.); example shown in FIG. 8. In a specific example, facial kinematics can be extracted from the video, wherein lip-reading methods are used with the extracted facial kinematics to convert the video to a text speech label. Ground truth measurements can optionally be used to validate, correct, and/or otherwise adjust another speech label. For example, a speech label including prompt text can be corrected based on ground truth measurements. An example is shown in FIG. 2.

In a first embodiment, speech labels associated with training data can be determined using ground truth measurements sampled concurrently with the training data. In a second embodiment, a speech label associated with training data can be predetermined (e.g., prompt text), wherein a training subject uses the speech label to generate training data (e.g., repeating the prompt text using voiced, silent, and/or whispered speech).

Speech labels can optionally be temporally aligned to the training data. In a first variant, the training data is segmented (e.g., into sentences, phrases, words, syllables, etc.), wherein each training data segment is aligned to a speech label. In a first embodiment, the training data is manually segmented post-hoc. In a second embodiment, the training data is manually segmented by the training subject or another person during training data collection. In a third embodiment, the training data is segmented using measurements acquired during training data collection (e.g., wherein the measurements are used to determine the start/end time of each training data segment). In a first example, automatic speech recognition is used on concurrently-sampled audio to output the start/end time for each voiced segment (e.g., word, phrase, etc.), wherein the start/end time for each voiced segment is used to determine the training data segment (e.g., EMG measurement) associated with the voiced segment. In a second example, lip-reading methods (e.g., including extracting facial kinematics from videos) are used to output the start/end time for each training data segment. In a third example, a pause detected using a measurement system (e.g., a microphone, an inertial sensor, etc.) can delineate a start/end time of a training data segment. In a second variant, the training data is not segmented. For example, the speech label is a text prompt of a phrase, wherein the training data associated with the user speaking (e.g., voiced, whispered, silently, etc.) is labeled with the entire text prompt.

However, the training data can be otherwise labeled.

Training a model at step 106 functions to train a model to decode silent speech. Step 106 preferably includes training the model using training data in the source domain (e.g., the voiced speech domain), but can alternatively include training data in the target domain, not include training data in the source domain, and/or include training data from any other suitable domain. In variants, source domain data has increased signal compared to target domain data, thus improving efficiency of training the model and/or increasing the accuracy of the trained model.

The model (e.g., silent speech decoding model, silent speech recognition model, etc.) can be or use one or more of: machine learning, deep learning, hidden Markov model (HMM), variants of HMM (e.g., HMM-GMM), regression (e.g., leverage regression), classification, neural networks (e.g., CNNs, DNNs, etc.), encoders, rules, heuristics, equations (e.g., weighted equations, linear functions, nonlinear functions, etc.), selection (e.g., from a library), instance-based methods (e.g., nearest neighbor), regularization methods (e.g., ridge regression), decision trees, Bayesian methods (e.g., Naïve Bayes, Markov, etc.), kernel methods, deterministics, genetic programs, support vectors, optimization methods, statistical methods (e.g., probability), comparison methods (e.g., matching, distance metrics, thresholds, etc.), clustering methods, and/or any other suitable method.

Inputs to the model can include: training data (in the source domain and/or the target domain), auxiliary measurements, and/or any other suitable outputs. The model inputs are preferably concurrently sampled, but can alternatively be sampled asynchronously. Outputs from the model can include: speech in text form, speech in audio form (e.g., generated speech audio), any other speech information (e.g., intonation), and/or any other suitable outputs.

The data used to train the model can be from the voiced domain, silent domain, whispered domain, and/or any other suitable domain. Measurement modalities used as inputs in model training can be the same as, different than, a superset of, and/or a subset of the measurement modalities used during inference (e.g., step 108).

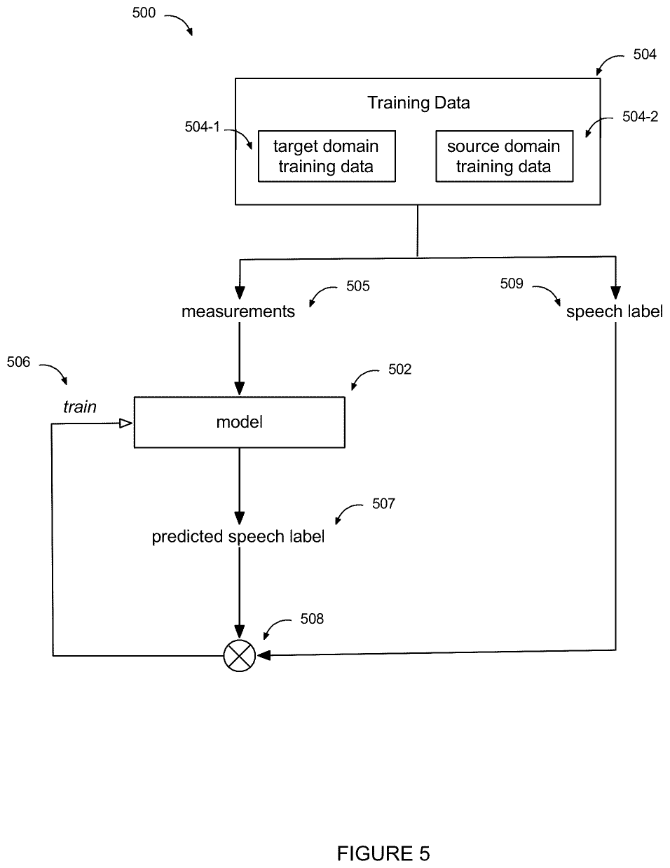

The model can be trained using self-supervised learning, semi-supervised learning, supervised learning, unsupervised learning, transfer learning, reinforcement learning, and/or any other suitable training method. An example of model training is shown in FIG. 5.

In a first variant, the model can be trained using only target domain training data. For example, the training data can include measurements sampled from a set of training subjects during silent speech (e.g., via step 102), wherein the training data is labeled (e.g., via step 104) with speech labels. The model can be trained to predict the speech labels based on the measurements.

In a second variant, the model can be trained using only source domain training data. Inference (e.g., step 108) using the trained model can be performed using target domain measurements as the input (e.g., without source domain measurements). For example, the training data can include measurements sampled from a set of training subjects during voiced speech (e.g., via step 102), wherein the training data is labeled (e.g., via step 104) with speech labels. The model can be trained to predict the speech labels based on the voiced speech measurements, then used to predict speech labels for silent speech measurements (e.g., illustrative example shown in FIG. 8).

In a third variant, the model can be trained using a combination of target domain training data and source domain training data. In a first embodiment, the training data includes randomly shuffled source domain training data and target domain training data. In a second embodiment, the model is initially trained using source domain training data (e.g., only source domain training data, above a threshold proportion of source domain training data, etc.), wherein the proportion of target domain data is increased in the training data in subsequent training iterations. In a third embodiment, the model is initially trained using source domain training data, and then the model is tuned using target domain training data (e.g., example shown in FIG. 8). In any embodiment, a conditioning flag (e.g., embedding, selective first layer, etc.) can optionally be used to tag model inputs with a collection domain (voiced, whispered, silent, etc.).

In a fourth variant, training the model includes training an ensemble model including a first model and a second model. The first model and the second model can be trained concurrently, asynchronously, using the same or a different set of training data, and/or otherwise trained. The models are preferably arranged in series (e.g., an output of the first model is used as an input to the second model, the first model is a set of preprocessing layers for model 2, etc.), but can alternatively be arranged in parallel and/or otherwise arranged.

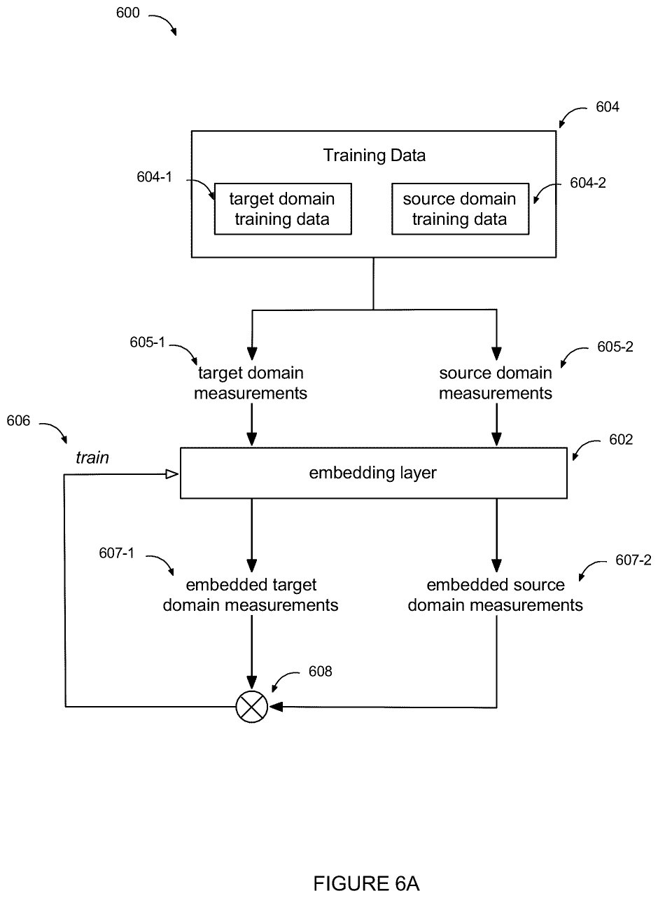

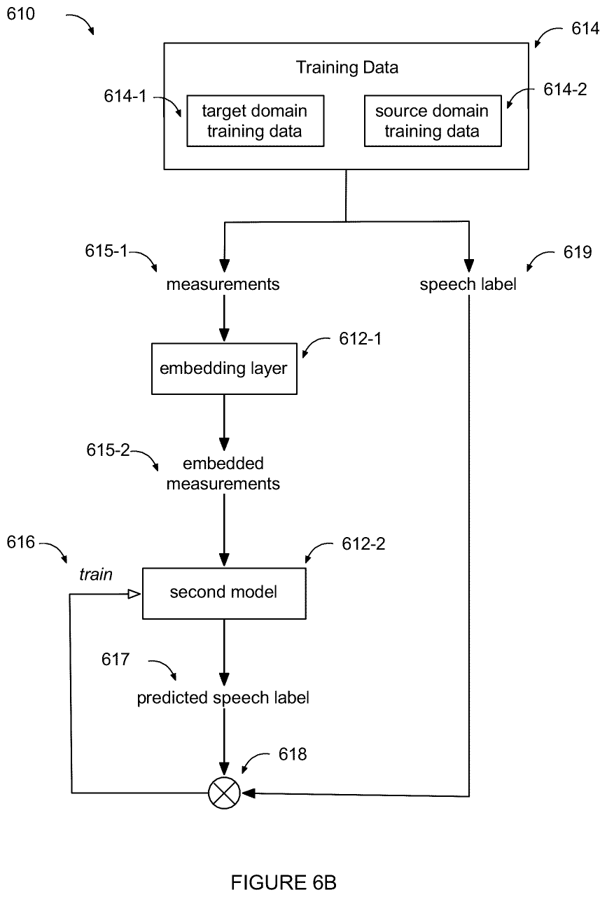

In a first embodiment, the first model is trained to transform target domain training data (e.g., silent speech measurements) to an embedding (e.g., a learned embedding, a common embedding, etc.), and the second model is trained to convert the embedding to a text and/or audio output. Examples are shown in FIG. 6A and FIG. 6B. For example, the first model can be trained using paired training data across source and target domains, wherein the first model can learn an embedding where the paired training data are embedded near each other. In a specific example, a first set of measurements are acquired during silent speech associated with a prompt, a second set of measurements are acquired during voiced speech associated with the same prompt, and the first model learns an embedding where the first and second sets of measurements are embedded at the same location. The second model can optionally be a set of layers (e.g., the decoder) from a model trained using the second variant (e.g., an autoencoder trained end-to-end using voiced speech measurements), wherein the first model (e.g., encoder) can be separately trained or tuned to determine the voiced speech embedding from silent speech sharing the same speech label (e.g., the same words).

In a second embodiment, the first model is trained to convert target domain training data (e.g., silent speech measurements) to synthetic source domain training data (e.g., synthetic voiced speech measurements), and the second model is trained (e.g., using a previous variant) to convert source domain training data to a text and/or audio output. An example is shown in FIG. 7. For example, the first model can be trained using paired training data across source and target domains, wherein the first model can learn the distribution of source domain data, the distribution of target domain data, and a translation from the target domain to the source domain. In a specific example, a first set of measurements are acquired during silent speech associated with a prompt, a second set of measurements are acquired during voiced speech associated with the same prompt, and the first model is trained to predict the second set of measurements based on the first set of measurements. The first model can optionally use any synthetic data generation methods in step 102.

In any variant, the model can optionally be trained using training data that includes different measurement modalities, wherein a subset of the modalities can be selected (e.g., for a training iteration, for a set of measurements, for a training subject, etc.). For example, the model can be initially trained using audio signals and EMG signals labeled with a speech label, wherein audio signals are not included in the training data in subsequent training iterations.

The model can optionally account for differences between individual users, between measurement sessions (e.g., each time EMG sensors are attached to the user), and/or any other attribute. In a first embodiment, a personalized model can be trained (e.g., retrained, tuned, calibrated, etc.) using training data (e.g., background training data) for the specific user and/or measurement session. In examples, training a personalized model can include: using a conditioning flag (e.g., indicating a user identifier, a measurement session identifier, etc.), using an additive embedding, using a first and/or last layer of the model network that is specific to the individual user and/or measurement session, training a generic model and then tuning the model using personalized training data, and/or any other training methods. In a second embodiment, the input measurements can be normalized. For example, a voiced and/or silent calibration procedure (e.g., with or without text prompts) can be used to establish a baseline, wherein subsequent measurements are normalized using the baseline.

However, the model can be otherwise trained.

Decoding silent speech using the model at step 108 functions to determine speech (e.g., in text form) that an end user is communicating via silent speech. Step 108 can be performed in real time (e.g., responsive to a request), asynchronously, after step 106, and/or at any other suitable time.

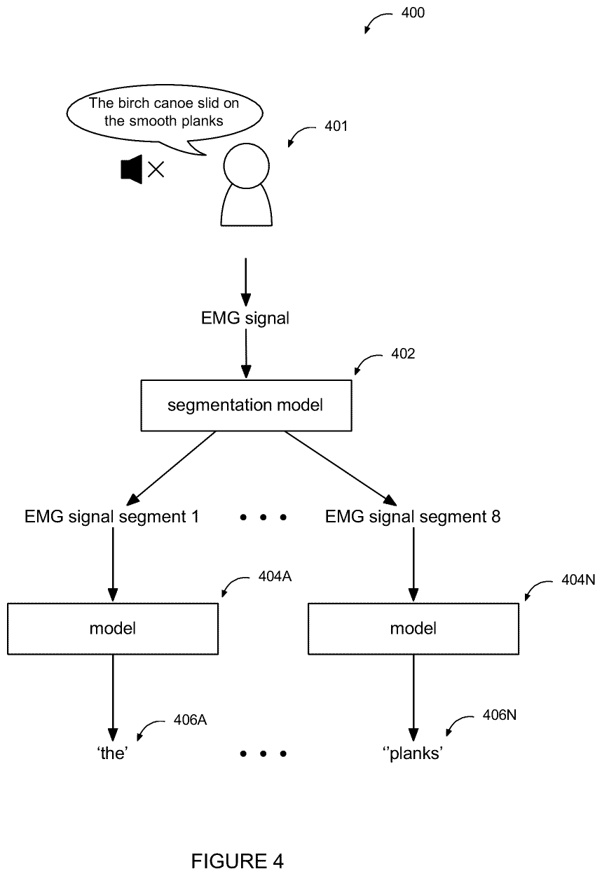

Decoding silent speech can include sampling a silent speech measurement (e.g., using step 102 methods), and using a silent speech decoding model (e.g., trained in step 106) to convert the measurement to a text and/or audio output. Examples are shown in FIG. 3 and FIG. 4. The silent speech measurement is preferably a measurement acquired in the target domain, but can alternatively be acquired in any other domain. The output can be presented at a user device, used to generate artificial audio, trigger an action (e.g., a request based on the speech output), and/or otherwise used.

In examples, decoding silent speech can be used for: making a silent phone call (e.g., the end user is silently speaking and the phone call recipient can hear the output), silent texting, silent requests (e.g., to recall information, perform a search, perform a calculation, ask a question, etc.), silent translations (e.g., the end user silently speaks in a first language and the output is a text or audio in a second language), silent transcription (e.g., to reduce strain from speaking), and/or for any other uses.

However, the model can be otherwise used.

Further details with respect to the examples described above will now be described with reference to the relevant figures.

FIG. 2 depicts an example of labeling training data, according to some embodiments. For example, FIG. 2 shows a scheme diagram of generating labeled training data for a speech model using different types of measurements to generate speech labels for the labeled training data. In some embodiments, labeled training data may include paired training data and speech labels as described above and further herein. In some embodiments, in generating the labeled training data, a speech label associated with training data may be predetermined. For example, the speech label may include a prompt that was used to prompt the user to speak when collecting the training data. In some embodiments, in generating the labeled training data, speech labels associated with training data may be determined using ground truth measurements sampled concurrently with the training data, where the training data (e.g., EMG signals indicating a user's speech muscle activation patterns) and the speech labels may be generated from the same or different domains.

As shown in FIG. 2, labeled training data 202 and labeled training data 204 are generated respectively in a voiced domain 206 (in which the user speaks in a voiced speech) and a silent domain 208 (in which the user speaks silently). In the voiced domain 206, the user is prompted with text 220 and the user speaks the prompt in a voiced speech. EMG signals are collected (e.g., using any of the modalities as described above and further herein) while the user is speaking in the voiced speech. Ground truth audio signal collected from the user speaking may be converted (e.g., using ASR) to a text speech label 210 to generate the labeled training data 202. In the silent domain 208, the user speaks the prompt in a silent speech. EMG signals are collected (e.g., using any of the modalities as described above and further herein) while the user is speaking silently. Ground truth video collected from the user speaking may be converted (e.g., using lip reading as described herein) to a text speech label 212 to generate the labeled training data 204.

In some embodiments, labeled training data generated in one domain may be corrected by ground truth measurements collected in another domain. For example, as shown in FIG. 2, labeled training data 204 generated from the speech label in the silent domain 208 may be corrected by the speech label 210 that was generated using the ground truth measurements collected in the voiced domain 206. In other variations, labeled training data 202 may be generated from the speech label 210 in the voiced domain and corrected from the speech label 212 generated in the silent domain.

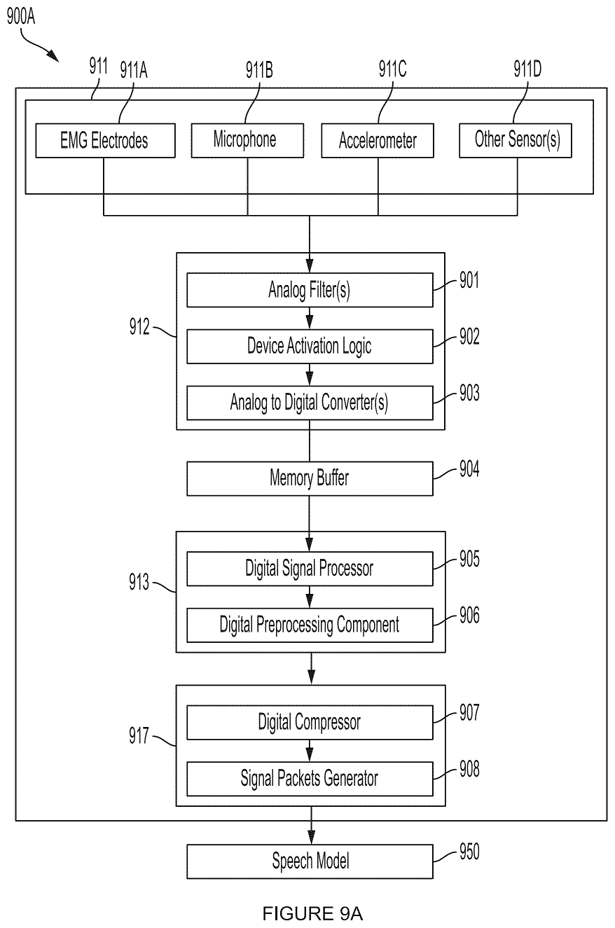

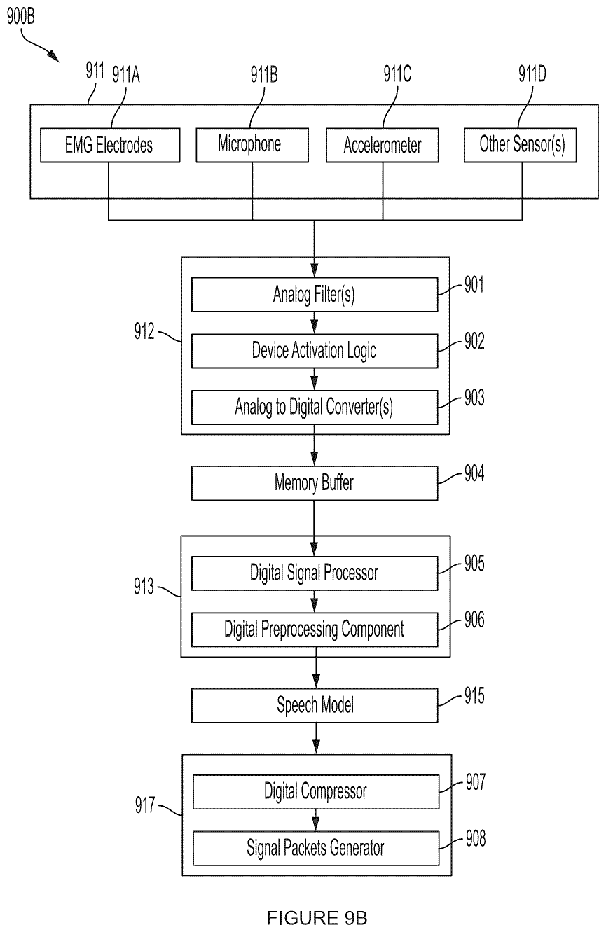

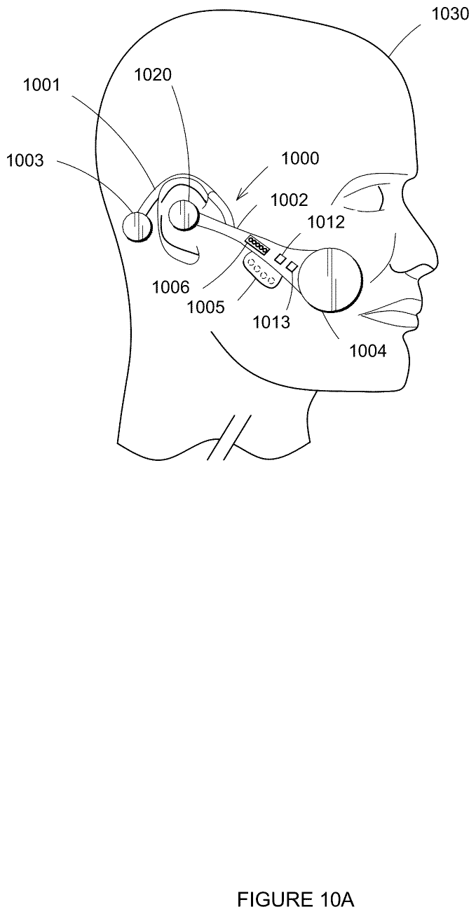

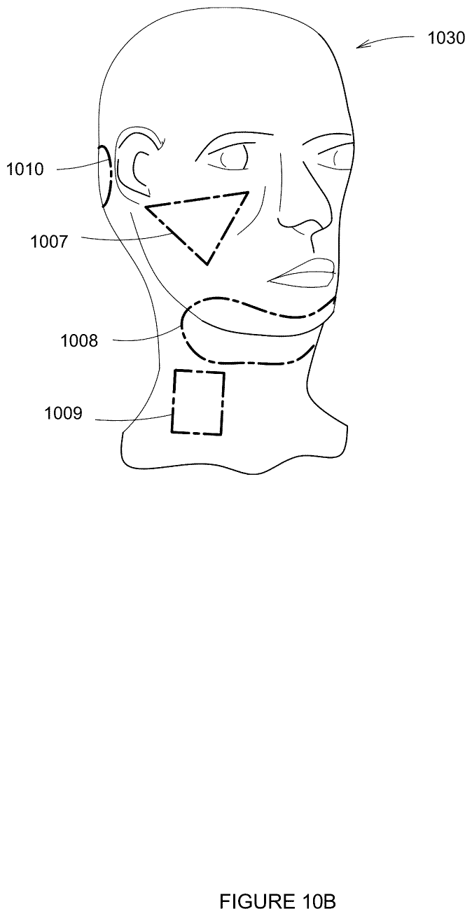

FIG. 3 depicts a first example of decoding silent speech. For example, FIG. 3 is a scheme diagram of a speech model configured to decode speech to predict text or encoded features using EMG signals, in accordance with some embodiments of the technology described herein. In some embodiments, the speech model 302 may be trained and installed in a speech input device (e.g., 900A in FIG. 9A, 900B in FIG. 9B, 1000 in FIG. 10A). Alternatively, the speech model 302 may be installed in an external device (e.g., 950 in FIG. 9A). When deployed (for inference), the speech model 302 may be configured to receive sensor data indicative of the user's speech muscle activation patterns (e.g., EMG signals) associated with the user's speech (voiced or silent) and use the sensor data to predict text or encoded features. As shown in FIG. 3, the user speaks silently “The birch canoe slid on the smooth planks.” The speech model 302 receives the EMG signals associated with the user's speech, where the EMG signals indicate the speech muscle activation patterns as discussed above and further herein. The speech model 302 outputs the text “The birch canoe slid on the smooth planks.”

In some embodiments, the sensor data indicating the user's speech muscle activation patterns, e.g., EMG signals, may be collected using a speech device such as shown and described in embodiments in FIGS. 9A-10A. The speech model 302 may be trained to use the sensor data to predict text or encoded features. Although it is shown that the EMG signals is associated with the user speaking silently, it is appreciated that the EMG signals may also be associated with the user speaking loudly, or in whisper, and may be used train the speech model to predict the text or encoded features. Thus, domain of the signals used for inference (target domain) and the domain for signals for training the speech model (source domain) may vary, as will be further described.

In some embodiments, training data for the speech model 302 may be associated with a source domain (collection domain). In some embodiments, the source domain may be a voiced domain, where the signals indicating the user's speech muscle activation patterns are collected from voiced speech of training subject(s). In some embodiments, the source domain may be a whispered domain, where the signals indicating the user's speech muscle activation patterns are collected from whispered speech of training subject(s). In some embodiments, the source domain may be a silent domain, where the signals indicating the user's speech muscle activation patterns are collected from silent speech of training subject(s).

As described herein in the present disclosure, voiced (vocal) speech may refer to a vocal mode of phonation in which the vocal cords vibrate during at least part of the speech for vocal phonemes, creating audible turbulence during speech. In a non-limiting example, vocal speech may have a volume above a volume threshold (e.g., 40 dB when measured 10 cm from the user's mouth). In some examples, silent speech may refer to unvoiced mode of phonation in which the vocal cords are abducted so that they do not vibrate, and no audible turbulence is created during speech. Silent speech may occur at least in part while the user is inhaling, and/or exhaling. Silent speech may occur in a minimally articulated manner, for example, with visible movement of the speech articulator muscles, or with limited to no visible movement, even if some muscles such as the tongue are contracting. In a non-limiting example, silent speech has a volume below a volume threshold (e.g., 30 dB when measured about 10 cm from the user's mouth). In some examples, whispered speech may refer to unvoiced mode of phonation in which the vocal cords are abducted so that they do not vibrate, where air passes between the arytenoid cartilages to create audible turbulence during speech.

In some embodiments, the target domain (e.g., a domain used for inference) may preferably be silent domain. In some embodiments, the target domain may be whispered domain. It is appreciated, that the target domain may also be voiced domain or any other domain. In some embodiments, the source domain may be voiced domain, whispered domain, silent domain, or a combination thereof. For example, the training data for the speech model may be collected from both voiced speech and silent speech, each contributing to a respective portion of the training data.

FIG. 4 depicts a second example of decoding silent speech, according to some embodiments. For example, FIG. 4 is a scheme diagram of a speech model 404 configured to decode speech to predict text or encoded features using EMG signals and segmentation of the EMG signals, in accordance with some embodiments of the technology described herein. As shown, FIG. 4 is similar to FIG. 3 with a difference in that the signals indicating the user's speech muscle activation patterns (e.g., EMG signals) are segmented by a segmentation model 402 before being provided to the speech model 404. In the example shown, the EMG signals are segmented into a number of segments (e.g., 1, 2, . . . , N). These EMG signal segments are provided to the speech model 404, which is configured to output the text corresponding to each of the EMG signal segments. In some embodiments, the EMG signals are segmented by word, for example, the speech “The birch canoe slid on the smooth planks” is segmented by eight segments each corresponding to a respective word in the speech. As shown, the speech model 404 may output eight words each corresponding to a respective EMG signal segment. Although it is shown that segmentation model 402 segments the EMG signals by word, it is appreciated that the segmentation model may also be trained to segment the EMG signals in any other suitable manner, where each segment may correspond to a phoneme, a syllabus, a phrase, or any other suitable segment unit. Accordingly, the speech model 404 may be trained to predict text that corresponds to a signal segment (e.g., EMG signal segment), where a segment may correspond to a segmentation unit, e.g., a sentence, a phrase, a word, a syllable etc. In some embodiments, training a speech model (e.g., 404) for predicting text segments may including generating segmented training data.

FIG. 5 depicts an example of training a model, according to some embodiments. For example, FIG. 5 is a scheme diagram 500 of training a speech model using training data collected in different domains, in accordance with some embodiments of the technology described herein. The speech model 502 may be trained using a combination of target domain training data and source domain training data 504, where the target domain training data and the source domain training data may be combined in different manners. In some embodiments, the training data 504 may include randomly shuffling source domain training data 504-2 and target domain training data 504-1. In some embodiments, the speech model 502 may be initially trained using source domain training data (e.g., only source domain training data, above a threshold proportion of source domain training data, etc.). In subsequent training iterations, an increased proportion of target domain training data may be used. In other embodiments, the speech model 502 may be initially trained using source domain training data, and subsequently, the speech model 502 may be tuned using target domain training data. It is appreciated that the target domain training and source domain training data may be combined in other suitable manners.

Although embodiments of dividing training data into target domain training data and source domain training data are shown in FIG. 5, in other variations, the speech model may optionally be trained using training data that includes different measurement modalities such as described above and further herein. In some embodiments, a subset of the modalities may be selected (e.g., for a training iteration, for a set of measurements, for a training subject, etc.). For example, the speech model may be initially trained using audio signals and EMG signals labeled with speech labels. In subsequent training iterations, only EMG signals and no audio signals are used.

In some embodiments, training data 504 may include training data obtained in a plurality of different sampling contexts. For example, target domain training data 504-1 and source domain training data 504-2 may include training data from their respective domains obtained during different sampling contexts. In some embodiments, the sampling contexts may include activity-based sampling contexts including, but not limited to, while the user is running, jogging, walking, standing, sitting, jumping, or performing any other activity, or a combination thereof. In some embodiments, the sampling contexts may include environment-based sampling contexts including environments with different noise levels, different radio frequency (RF) properties, different electrical properties (e.g., varying electrical noise levels), varying vibrational noise levels, different acoustic properties, or other varied environmental properties, or a combination thereof. Alternatively, each of the different sampling contexts may define a different domain or sub-domain for the training data, for example, training data obtained while the user is running may be a domain separate form target domain training data 504-1 and source domain training data 504-2 or may be a sub-domain of either 504-1 or 504-2. Similarly, training data obtained while the user is in a noisy environment may be a separate domain or sub-domain distinct from other training data obtained in different sampling contexts.

In some embodiments, the sampling contexts may include a plurality of different vocal levels as opposed to just vocal and silent speech. For example, training data 504 may include training data obtained from a discrete spectrum of vocal levels, for example, 10 levels, 20, levels, or any suitable number of levels between and including silent and vocal speech as described herein. Each level may be grouped as a separate domain so that training data 504 has a number of domains equal to the number of vocal levels. Alternatively, the spectrum of vocal levels may be a continuous spectrum of vocal levels between and including silent and vocal speech rather than a discrete spectrum.

In some examples, the model may be an ensemble model with an embedding layer. FIG. 6A depicts an example of training an ensemble model, including training an embedding layer according to some embodiments. For example, FIG. 6A is a scheme diagram 600 of training a speech model with an embedding layer using training data collected in different domains, in accordance with some embodiments of the technology described herein. The speech model with embedding layer 602 may be trained using a combination of target domain training data and source domain training data 604, where the target domain training data and the source domain training data may be combined in different manners. In some embodiments both target domain measurements 605-1 and source domain measurements from target domain training data 604-1 and source domain training data 604-2 may be inputted into embedding layer 602. Embedding layer 602 may then produce as output embedded target domain measurements 607-1 and embedded source domain measurements 607-2 which can be blended or shuffled or otherwise combined at function 608 and used to further train embedding layer following training path 606.

In some examples, the model may be an ensemble model including more than one model and an embedding layer. FIG. 6B depicts an example of training an ensemble model, including training a model to decode embedded training data, according to some embodiments. For example, FIG. 6B is a scheme diagram 610 of training a speech model using training data collected in different domains, in accordance with some embodiments of the technology described herein. Scheme diagram 610 is substantially similar to scheme diagram 500, with the difference being an embedding layer 612-1 being used to embed measurements 615-1 so as to output embedded measurements 615-2. The embedded measurements 615-2 are used as inputs to a second model 612-2 to determine predicted speech labels 617 which can be used in combination with speech labels 619 to train second model 612-2.

It can be appreciated that an ensemble model can be configured in a number of different ways and may include different architecture. Accordingly, FIG. 7 depicts a second example of training an ensemble model, according to some embodiments. For example, FIG. 7 is a scheme diagram 700 of training a speech model with multiple models, according to some embodiments. FIG. 7 is different than FIG. 5 in that a first model 702-1 is used to produce synthetic source domain measurements (e.g. synthetic voiced speech measurements) using the target domain measurements 705-1. The synthetic source domain measurements 707-1 and source domain measurements 705-2 are then used to train the first model 702-1. Both synthetic source domain measurements 707-1 and source domain measurements 705-2 can be used as inputs to second model 702-2 to produce a predicted speech label 707-2. The predicted speech label 707-2 can then be used in combination with speech label 709 to train second model 702-2.

As discussed above, the models and methods of training the models can be used to decode silent speech by using and training a silent speech decoding model. FIG. 8 depicts an illustrative example of training a silent speech decoding model using voiced speech training data, according to some embodiments. User 800 may produce various voiced and silent speech measurements which may be detected by speech input device 801, details of which will be described with respect to FIGS. 9A-10B below. The model or models may first be trained on voiced speech data 805-2 which can include one or more of audio, video, voiced speech speech muscle signals (e.g., EMG signals), and other auxiliary measurements. The audio and/or video may be used to determine a speech label 804. In some embodiments, speech label 804 may be based on a prompt given to user 800. The voiced speech muscle signals and auxiliary measurements may be used as inputs to model 802 to determine a predicted speech label 807A. The speech label 804 and predicted speech label 807A may then be used to train model 802, as discussed herein.

After training model 802 on voiced speech data, model 802 may be tuned based on silent speech measurements (e.g., silent speech EMG 805-1) produced by user 800 and detected by speech input device 801. Silent speech EMG 805-1 may be used as input to model 802 to determine predicted speech label 807B. Speech label 804 may be the same speech label associated with a same prompt used in training the model using voiced speech data. Speech label 804 and predicted speech label 807B may then be used to tune model 802.

After tuning, model 802 may then be used to decode silent speech, for example silent speech EMG 805-1. Model 802 may decode silent speech EMG 805-1 by determining predicted speech label 807C. Predicted speech label 807C may then be further processed into an audio or text output to be outputted by a suitable device, for example, a suitable output component (e.g., speaker, display) of speech input device 801.

Any of the above exemplary model embodiments may be implemented by a speech input device or, alternatively, implemented by an external device communicatively coupled with a speech input device. FIGS. 9A and 9B depict an exemplary speech input devices, according to some embodiments. FIG. 9A depicts a scheme diagram of an example speech input device 900A capable of communicating with an external speech model 950, according to some embodiments. In some embodiments, the speech input device 900A may include one or more sensors 911, which record signals indicating a user's speech muscle activation patterns associated with the user speaking (e.g., in a silent, voiced, or whispered speech). In non-limiting examples, the one or more sensors 911 may include one or more EMG electrodes 911A, a microphone 911B, an accelerometer 911C and/or other suitable sensors 911D. The signals collected from the sensors may be analog signals which are provided to the signal processing unit of the speech input device.

In some embodiments, the speech input device 900A may include a signal processing unit 912, one or more processors 913, and a communication interface 917. The signal processing unit 912 may include one or more analog filters 901, a device activation logic 902, and one or more analog-to-digital converters 903. The analog filters 901 may be used to improve the quality of the signals for later processing. For example, the analog filters 901 may include a high-pass filter, a low-pass filter, a bandpass filter, a moving average filter, a band stop filter, a Butterworth filter, an elliptic filter, a Bessel filter, a comb filter, and a gaussian filter, or a combination thereof. It is appreciated that the analog filters many include other suitable filters. The analog filters 901 may be implemented as a circuitry within the speech input device 900A.

The device activation logic 902 may analyze the filtered signals provided from the analog filter(s) 901 to determine the presence of one or more activation signals recognized from the analog signals. For example, a user may say a particular word or phrase out loud, which is recorded by the microphone. The device activation logic 902 may recognize this word or phrase and in response will perform one or more actions. The one or more actions may include changing a mode of the device, activating one or more features of the device, and performing one or more actions. The device activation logic 902 may analyze analog filtered signals as shown, unfiltered analog signals, digital signals, filtered digital signals and/or any other signal recorded from the one or more sensors. The device activation 902 logic may operate on signals from any of the sensors, e.g., the EMG electrodes 911A, the microphone 911B, the accelerometer 911C, and any other sensors 911D in the speech input device 900A. Although the device activation logic 902 is shown to be implemented in signal processing unit 912, it is appreciated that the device activation logic 902 may be implemented in any suitable component of the speech input device 900A, e.g., one or more processors 913.

In some embodiments, digital converters 903 may convert analog signals to digital signals. The signals input to the analog-to-digital converters may be filtered or unfiltered signals. For example, analog signals from the one or more sensors (e.g., 911) may be directly passed to one or more analog-to-digital converters 903 without the analog filters 901. In some embodiments, there may be a respective individual analog-to-digital converter for each sensor (e.g., any of 911). The one or more analog-to-digital converters 903 may be implemented as circuitry within the speech input device 900A, e.g., a chip or application specific integrated circuit (ASIC). Any suitable analog-to-digital converter circuit configuration may be used.

In some embodiments, the one or more processors 913 may perform a series of processes on the signals received from the sensors. As shown, the one or more processors 913 may process signals from the one or more sensors 911, or via the signal processing unit 912. Additionally, and/or alternatively, the speech input device 900A may include one or more memory buffers 904. The memory buffers 904 may temporarily store data as it is transferred between the signal processing unit 912 and one or more processors 913, or between any other internal units of the one or more processors 913, or between any components of the speech input device 900A. The memory buffers 904 may be implemented as hardware modules or may be implemented as software programs which store the data in a particular location within a memory of the speech input device 900A. The memory buffers 904 may store data including analog and/or digital signals, such as filtered signals from analog filter(s) 901, digital signals from analog-to-digital converter(s) 903, control signals from the device activation logic 902, and any other data from within the speech input device 900A.

In some embodiments, the one or more processors 913 may include a digital signal processor 905 configured to perform digital signal processing on digital signals from the analog-to-digital converter(s) 903, for example, or digital data stored in the memory buffer 904. In some embodiments, digital signal processor 905 may process the digital signals and improve the quality thereof for later processes. In some embodiments, the digital signals may undergo one or more digital processing operations in the digital signal processor 905. In some embodiments, the digital processing in the digital signal processor 905 may be tailored to specific signals, e.g., signals from the EMG electrodes 911A, which may undergo specific digital processing that is different from processing executed on signals recorded from the microphone 911B. Examples of digital signal processing performed in the digital signal processor 905 include digital filtering of the signals, feature extraction, Fourier analysis of signals, Z-plane analysis, and/or any other suitable digital processing techniques.

In some examples, the digital signal processor 905 may include one or more layers of a neural network and/or a machine learning model maintained by the speech input device to generate digital signal vector(s). Additionally, and/or alternatively, the one or more processors 913 may include a digital preprocessing component 906 configured to perform one or more preprocessing operations, e.g., normalization of data, cropping of data, sizing of data, reshaping of data, and/or other suitable preprocessing actions.

In some embodiments, the communication interface 917 may be configured to receive signals from other units, e.g., 911, 912, 913, and prepare data for further processing. In some embodiments, the communication interface 917 may include a digital compressor 907 configured to compress the received signals and a signal packets generator 908 configured to perform signal packaging for transmission. In some embodiments, the signals received at the communication interface 917 may undergo digital compression at the digital compressor 907 and the compressed data from digital compressor 907 may be packaged for transmission. In non-limiting examples, digital compression may be performed at digital compressor 907 on one or more signals in order to reduce the amount of data transmitted by the speech input device. Digital compression performed at digital compressor 907 may use any suitable techniques, e.g., lossy and lossless compression techniques.

In some embodiments, signal packaging may be performed at signal packets generator 908 to format (e.g., packetize) data for transmission according to a particular transmission modality. For example, a signal may be packetized with additional information to form a complete Bluetooth packet for transmission to an external Bluetooth device. In the example shown in FIG. 9A, the packetized signal may be sent to an external device having a speech model 950 for converting to text, for example.

FIG. 9B depicts a scheme diagram of an example speech input device 900B including a speech model 915, according to some embodiments. In some embodiments, speech input device 900B may have a similar configuration as speech input device 900A (FIG. 9A) with a difference being that speech input device 900B in FIG. 9B includes an embedded speech model 915, rather than the speech model being external to the speech input device as is speech model 950 in FIG. 9A. Thus, the numerals in FIG. 9A and numerals in FIG. 9B may correspond to similar components that perform substantially the same function. For example, 911 in FIG. 9B may correspond to one or more sensors 911 in FIG. 9A for capturing electrical signals indicating the user's speech muscle activation patterns or other measurements when the user is speaking (e.g., in a voiced, silent, or whisper speech). Similarly, 912 in FIG. 9B may correspond to signal processing unit 912 in FIG. 9A.

As shown in FIG. 9B, speech input device 900B may additionally include a speech model 915 configured to covert the digital signals from one or more processors 913 to text or encoded features. With further reference to FIG. 9B, speech model 915 may provide the text or encoded features to the communication interface 917 for transmitting to an external device. In some embodiments, the communication interface 917 may transmit the compressed/packetized text or encoded features to an application on the external device via a communication link such as a wired connection or a wireless connection.

In some embodiments, the speech input devices described herein may be implemented as a wearable speech input device. FIG. 10A is a perspective view of a wearable speech input device 1000 having an ear hook embodiment and wearable on a user's ear, in accordance with some embodiments of the technology described herein. The wearable speech input device 1000 may be an example implementation of the speech input device, e.g., 900A (FIG. 9A), 900B (FIG. 9B) as described in embodiments in FIGS. 9A-9B. In some embodiments, the wearable device 1000 may include an ear hook portion 1001 configured to fit around the top of a user's ear. The ear hook 1001 may support a sensor arm 1002 of the wearable device 1000 and a reference electrode 1003 of the device. The ear hook 1001 may be adjustable to conform to the anatomy of a user 1030. The wearable device 1000 may additionally include one or more inputs 1006 (e.g., buttons) accessible to the user 1030 while the wearable device 1000 is being worn.

With further reference to FIG. 10A, the wearable device 1000 may include a sensor arm 1002, supported by the ear hook 1001. The sensor arm 1002 may contain one or more sensors 1005 for capturing speech signals indicating a user's speech muscle activation patterns or other measurements from the user 1030 when the user is speaking. The one or more sensors 1005 may include any of the sensors 911 (FIGS. 9A-9B) or any other suitable sensors. In some embodiments, the one or more sensors supported by the sensor arm may include EMG electrodes 1004 configured to detect EMG signals associated with the user speaking. The EMG electrodes 1004 may be configured as an electrode array or multiple electrode arrays supported by the sensor arm 1002 of the wearable device 1000. Although the EMG electrodes 1004 are shown to be positioned at a distal end of the sensor arm 1002, in other embodiments, the EMG electrodes 1004 may be dispersed over the sensor arm. The one or more electrode arrays may have any suitable shapes e.g., a circular, a square, a rectangular, or any other suitable shape. The sensor arm 1002 may be configured to provide a force to maintain contact between the face of the user and the EMG electrodes, which are located on a side of the sensor arm 1002, facing the user 1030.

In some embodiments, the sensors 1005 may include a microphone for recording voiced or whispered speech, and an accelerometer or IMU for recording motion associated with speech. The sensors 1005 may additionally include sensors configured to measure a position of a user's tongue, blood flow of the user, muscle strain of the user, muscle frequencies of the user, temperatures of the user, and magnetic fields of the user, or a combination thereof, or any other suitable measurements. For example, the sensors 1005 may include photoplethysogram (PPG) sensors, photodiodes, optical sensors, laser doppler imaging, mechanomyography sensors, sonomyography sensors, ultrasound sensors, infrared sensors, functional near-infrared spectroscopy (fNIRS) sensors, capacitive sensors, electroglottography sensors, electroencephalogram (EEG) sensors, and magnetoencephalography (MEG) sensors, or any other suitable sensors. Further, the sensors 1005 may include a camera or other optical sensor for capturing video of the user, to be used in training the models described herein.

With further reference to FIG. 10A, in some embodiments, the one or more sensors 1005 may include a reference electrode 1003. Ear hook 1001 may additionally support the reference electrode 1003. The reference electrode 1003 may be disposed on a side of the ear hook 1001, facing the user 1030. In some examples, the reference electrode 1003 may be used in conjunction with the electrodes 1004 supported by the sensor arm 1002 as inputs to a differential amplifier. The reference electrode 1003 may provide a first potential or voltage to the user. The electrodes 1004 supported by the sensor arm 1002 may record electrical signals at the face of the user. The differential amplifier may take as inputs a voltage equal to that of the reference electrode 1003 and electrical signals recorded by the electrodes 1004 supported by the sensor arm 1002. The differential amplifier may amplify a difference between input voltages from electrical signals recorded by the reference electrode 1003 and the electrical signals recorded by the electrodes 1004, representing the voltage generated by the muscles in the face of the user. Additionally, the differential amplifier may suppress any voltages common to the two inputs. The reference voltage supplied to the face of the user by the reference electrode 1003 will be recorded by the electrodes 1004 supported by the sensor arm 1002, in addition to the voltage generated by muscles in the face of the user. In some embodiments, a suitable circuitry (e.g., a chip, an ASIC) for the differential amplifier may be contained within the wearable device 1000.

In some embodiments, the wearable device 1000 may include a speaker 1020 positioned at an end of the sensor arm. The speaker 1020 is positioned at the end of the sensor arm 1002 configured to be positioned proximate to the user's ear. In some embodiments, the speaker 1020 may be inserted into the user's ear to play sounds (e.g., via bone conducting). In some embodiments, the speaker 1020 may play sounds aloud adjacent to the user's ear. The speaker 1020 may be used to play outputs of silent speech processing or communication signals as discussed herein. For example, the speaker may play output of the speech model (915 in FIG. 9B) via text to speech (TSS) techniques. In addition, the speaker 1020 may be used to play one or more outputs from a connected external device, or the wearable device, such as music, audio associated with video or other audio output signals. Although a limited number of components are shown in FIG. 10A, it is appreciated that the wearable device 1000 may include other components, which may be needed to make the wearable device 1000 functional. For example, the wearable device 1000 may include one or more processors 1012 configured to perform any operations as described above and further herein. Additionally, and/or alternatively, wearable device 1000 may include a speech model 1013 to convert sensor data from the sensors to text or encoded features as described above and further herein. Additionally, and/or alternatively, the wearable device 1000 may include a charging port, a data transfer port, or any other suitable components.

FIG. 10B is an illustration of wearable device target zone(s) associated with a wearable speech input device such as wearable device 1000 (FIG. 10A), in accordance with some embodiments of the technology described herein. The target zones may include one or more areas on or near the user's body part, in which sensor(s) can be placed to measure speech muscle activation patterns while the user is speaking (silently or with voice). For example, the speech muscle activation patterns at various target zones may include facial muscle movement, neck muscle movement, chin muscle movement, or a combination thereof associated with the user speaking. In some examples, the sensors may be placed at or near a target zone at which the sensors may be configured to measure the blood flow that occurs as a result of the speech muscle activation associated with the user speaking. Thus, the wearable device 1000 may be configured to have its sensors positioned to contact one or more target zones, such as the face and neck of the user.

With further reference to FIG. 10B, various target zones are shown. In some embodiments, a first target zone 1007 may be on the cheek of the user 1030. This first target zone 1007 may be used to record electrical signals associated with muscles in the face and lips of the user, including the zygomaticus of the user, the masseter of the user, the buccinator of the user, the risorius of the user, the platysma of the user, the orbicularis oris of the user, the depressor anguli oris of the user, the depressor labii, the mentalis, and the depressor septi of the user.

In some embodiments, various sensors may be positioned at the first target zone 1007. For example, electrodes (e.g., 1004 in FIG. 10A) supported by the wearable device 1000 (e.g., via a sensor arm 1002) may be positioned to contact the first target zone 1007 of the user. In some embodiments, sensors configured to measure the position and activity of the user's tongue may be supported at the first target zone 1007 by the sensor arm. In some embodiments, accelerometers configured to measure movement of the user's face may be placed at the first target zone 1007.

In some embodiments, a second target zone 1008 is shown along the jawline of the user. The second target zone 1008 may include portions of the user's face above and under the chin of the user. The second target zone 1008 may include portions of the user's face under the jawline of the user. The second target zone 1008 may be used to measure electrical signals associated with muscles in the face, lips jaw and neck of the user, including the depressor labii inferioris of the user, the depressor anguli oris of the user, the mentalis of the user, the orbicularis oris of the user, the depressor septi of the user, the mentalis of the user, the platysma of the user and/or the risorius of the user. Various sensor may be placed at the second target zone 1008. For example, electrodes (e.g., 1004 in FIG. 10A) supported by the wearable device 1000 (e.g., via a sensor arm 1002) may be positioned to contact the second target zone 1008. Additional sensors, e.g., accelerometers, may be supported by the wearable device and positioned at the second target zone 1008 to measure the movement of the user's jaw. Additional sensor may also include sensors configured to detect the position and activity of the user's tongue.

In some embodiments, a third target zone 1009 is shown at the neck of the user. The third target zone 1009 may be used to measure electrical signals associated with muscles in the neck of the user, e.g., the sternal head of sternocleidomastoideof the user, or the clavicular head of sternocleidomastoideous sensors may be positioned at the third target zone 1009. For example, accelerometers may be supported at the third target zone to measure vibrations and movement generated by the user's glottis during speech, as well as other vibrations and motion at the neck of user 1030 produced during speech.

In some embodiments, a reference zone 1010 may be located behind the car of the user at the mastoid of the user. In some embodiments, reference electrodes (e.g., 1003 in FIG. 10A) may be positioned to contact the reference zone 1010 to supply a reference voltage to the face of the user, as discussed herein. Reference zone 1010 may also include portions of the user's head behind and above the car of the user.

With reference to FIGS. 10A and 10B, as discussed with reference to multiple target zones for measuring the user's speech muscle activation patterns associated with the user speaking, the wearable device 1000 may include various mechanisms to adjust the positions of sensors for accommodating one or more target zones. For example, the sensor arm (e.g., 1002) of the wearable device 1000 may be adjustable along the axis of the sensor arm to enable the electrodes (e.g., 1004 in FIG. 10A) on the sensor arm to align with a target zone. In some embodiments, one or more parts of the wearable device 1000 may be moveable laterally, for example, to enable the sensor(s) thereon to be closer or further away from the user's body part (e.g., face or neck). In some embodiments, the wearable device 1000 may include multiple sensor arms wearable on both sides of the face to enable multiple sets of sensors on either or both sides of the face or neck. It is appreciated that other suitable configurations may be possible to enable any sensors to be suitably positioned in respective target zones.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

What is claimed:

1. A system for decoding speech of a user, the system comprising:
a speech input device configured to measure a signal indicative of the speech muscle activation patterns of the user while the user is speaking;
a trained machine learning model configured to decode the speech of the user based at least in part on the signal indicative of the speech muscle activation patterns of the user, wherein:
the trained machine learning model is trained using training data obtained in at least a subset of sampling contexts of a plurality of sampling contexts; and
at least one processor configured to output the decoded speech of the user.

2. The system of claim 1, wherein:
the plurality of sampling contexts comprise a plurality of vocalization levels.

3. The system of claim 2, wherein:
the plurality of vocalization levels comprise a spectrum of vocalization levels from silent speech to vocalized speech.

4. The system of claim 3, wherein:
the spectrum of vocalization levels from silent speech to vocalized speech comprises a discrete spectrum of vocalization levels.

5. The system of claim 3, wherein:
the spectrum of vocalization levels from silent speech to vocalized speech comprises a continuous spectrum of vocalization levels.

6. The system of claim 2, wherein:
the plurality of sampling contexts further comprises a plurality of activity-based sampling contexts.

7. The system of claim 6, wherein:
the plurality of activity-based sampling contexts comprise two or more of: walking, running, jumping, standing, or sitting.

8. The system of claim 2, wherein:
the plurality of sampling contexts further comprises a plurality of environmental-based sampling contexts.

9. The system of claim 8, wherein:
each of sampling contexts of the plurality of environmental-based sampling contexts are based at least in part on a location and a noise level of the sampling context.

10. The system of claim 8, wherein:
each of the sampling contexts of the plurality of environmental-based sampling contexts are based at least in part on the electrical properties of the sampling context.

11. The system of claim 1, wherein:
the trained machine learning model is associated with the user.

12. The system of claim 11, wherein:
the trained machine learning model comprises a plurality of layers; and
associating the trained machine learning model with the user comprises associating at least one layer of the plurality of layers with the user.

13. The system of claim 11, wherein:
at least a subset of the training data is obtained from signals produced by the user; and
associating the trained machine learning model with the user comprises training the machine learning model using the subset of the training data obtained from signals produced by the user.

14. The system of claim 11, wherein:
associating the trained machine learning model with the user comprises using as input to the trained machine learning model, a conditioning flag associated with the user.

15. The system of claim 1, wherein;
the speech input device is further configured to obtain voiced speech measurements when the user is speaking vocally; and
the trained machine learning model is a first trained machine learning model configured to associate a first signal indicative of the speech muscle activation patterns of the user when the user is speaking silently with a first voiced speech measurement when the user is speaking vocally; and
the system further comprises a second trained machine learning model configured to generate an audio and/or text output when the user is speaking silently based at least in part on the association of the first signal indicative of the speech muscle activation patterns of the user with the first voiced speech measurement.
